(19) United States
(12) Patent Application Publication
(10) Pub. No.: US 2026/0358891 A1
(43) Pub. Date: Nov. 12, 2026

(54) System and Method for Remote Physical Object Interaction Using Augmented Reality and Haptic Feedback

(71) Applicant: Hayden Watt, Bowmanville (CA)

(72) Inventor: Hayden Watt, Bowmanville (CA)

(21) Appl. No.: 19/199,533

(22) Filed: May 6, 2025

(51) Int. Cl. G06F 3/01

(52) U.S. Cl. CPC G06F 3/016; G06F 3/011

(57) ABSTRACT

A system and method for remote physical object interaction using synchronized augmented reality and haptic feedback is disclosed. The system enables two or more users at separate locations to manipulate a shared physical or virtual object in real time through a synchronization protocol, a feedback delivery mechanism, and an augmented reality interface. The synchronization protocol transmits bidirectional object state data with latency minimization. The feedback delivery mechanism provides haptic, tactile, vibrational, auditory, and visual signals replicating physical touch across endpoints. The system supports wearable devices, environmental emitters, and predictive synchronization to forecast user actions and maintain continuity. This invention allows global physical collaboration, training, prototyping, and shared digital-physical environments in a hardware-neutral format.

### TECHNICAL FIELD

This invention relates generally to augmented reality (AR), virtual reality (VR), and extended reality (XR) systems, and more specifically to systems and methods enabling multiple remote users to interact with real-world tangible objects through synchronized AR interfaces combined with haptic feedback mechanisms.

### BACKGROUND OF THE INVENTION

### Explains the Current State of Technology

Augmented reality and virtual reality technologies have enabled users to interact with digital representations of objects and environments.

However, current systems are limited primarily to visual and auditory experiences.

Existing AR/VR platforms allow users to see and sometimes hear remote environments but do not enable users in different physical locations to touch, move, or physically manipulate real-world objects together across distance.

There remains a need for a system that enables remote, real-time, tangible physical interaction between users, blending the physical and digital worlds seamlessly.

### SUMMARY OF THE INVENTION

The present invention provides a system and method that allows users located in separate physical environments to see, touch, move, and interact with real tangible objects together through augmented reality interfaces and synchronized haptic feedback devices.

Each user's physical environment is scanned and mapped into a shared 3D digital space.

Objects within these environments are tagged with tracking components (such as RFID chips, QR markers, or computer vision markers).

Real-time object position data is synchronized across users via a cloud-based server.

When one user interacts with a physical object (picking it up, moving it, rotating it), the corresponding virtual or physical object in the remote user's environment reacts accordingly combined with haptic feedback to simulate touch, weight, texture, and resistance.

### System Components

The system comprises the following primary components:

### AR/XR Device:

Head-mounted displays, AR glasses, VR headsets, or mobile devices that enable visual overlay of the synchronized virtual environment onto the user's physical surroundings.

### Object Tracking System:

Physical markers, RFID chips, QR codes, NFC tags, or computer vision systems attached to real-world objects to track their positions, orientation, and state.

### Environmental Scanning Hardware:

Sensors such as LiDAR scanners, stereo cameras, or depth perception devices for real-time mapping of the user's environment into a digital twin.

### Synchronization Server:

A centralized or distributed cloud-based server that synchronizes environment data, object state data, and user interactions between multiple remote locations in real time.

### Haptic Feedback Devices:

Wearable gloves, sleeves, handheld controllers, or skin-contact patches that deliver physical feedback (pressure, vibration, weight sensation) corresponding to remote object interactions.

### (Optional) Object Actuation Mechanisms:

Robotic arms, magnetic movers, or other smart devices capable of moving lightweight physical objects remotely in response to remote user actions.

### HOW THE SYSTEM WORKS

### 1. Environment Setup

Users in separate locations set up their AR/XR devices and physical objects.

Each physical object is tagged and registered into the system.

### 2. Environment Mapping

The user's environment is scanned and mapped into a digital twin environment.

Object positions and states are uploaded to the cloud server.

### 3. Remote Synchronization

Real-time synchronization allows users to see the same shared environment.

If User A moves an object, User B sees the corresponding object move through AR overlay.

Haptic feedback is triggered for User B, simulating the force, weight, and resistance of the object.

### 4. Physical Interaction

Users can collaborate, build, design, or play by physically interacting with real-world tangible objects across distance.

Movements are not limited to visuals real “touch” sensations are provided through haptics.

### Key Innovations

### Remote Physical Tangibility

Allows users to physically feel and manipulate objects together across different real-world spaces.

### Real-Time Object Synchronization

Instant updates and movements mapped and transmitted with near-zero latency.

### Bidirectional Physical Feedback

Both users experience synchronized tactile sensations corresponding to real-world object manipulations, providing a tangible sense of shared physical presence beyond visual representation.

### Modular Design

Compatible with multiple AR/XR platforms, wearable haptic devices, and future smart environments.

Future improvements to the system may include:

### Shared Tactile Environment Simulation:

Enhancing remote collaboration by allowing users to experience full environmental texture changes, such as simulating surface types (e.g., rough, smooth, liquid) during interaction.

### Remote Robotic Actuation Assistance:

Integration of small-scale robotic movers capable of physically repositioning tangible objects in remote environments under the command of user interactions.

### Adaptive AI Synchronization:

Using AI to predict and compensate for minor latency or environmental mapping errors to create seamless real-time physical interactions.

### Multi-user Haptic Group Collaboration:

Allowing multiple remote users to interact with the same physical object simultaneously, with haptic feedback adjusting dynamically for each participant.

### Continuation-in-Part Additions

1.

A comprehensive clause extending the definition of “physical feedback” to encompass not only. any tactile, auditory, vibrational, thermal, or electro-sensory signal that is contextually linked to object interaction or user biometric state, but also any olfactory cue, gustatory stimulus, vestibular or balance illusion, nociceptive signal, magnetic or electromagnetic field-induced sensation, direct neural modulation or neurostimulation, and any other form of neurosensory substitution or perception-altering channel by which a user may experience the sensation of touch, force, texture, weight, motion, or environmental change, regardless of whether such signals are delivered via mechanical actuators, wearable devices, implanted interfaces, ambient projection systems, chemical delivery, or any combination thereof, when employed to simulate, recreate, or evoke shared object interaction or co-presence between two or more users in physically separate locations.
2.

A detailed clause redefining “object” to include any entity physical, virtual, emergent, AI-generated, algorithmic, ephemeral, hydraulic, pneumatic, fluidically coupled, or constituted by ambient spatial variables such as dynamic light fields, programmable soundscapes, temperature gradients, pressure differentials, electromagnetic fields, or other environmental parameters so long as two or more endpoints recognize, treat, or manipulate such entity as possessing shared state or manipulable properties, whether through direct contact, proxy representation, symbolic reference, or inferred correlation, such that any alteration, movement, or state change at one endpoint corresponds to a perceivable alteration, movement, or state change at another endpoint.
3.

A rigorous clause requiring that any two or more devices, systems, or conduits whether connected via centralized servers, peer-to-peer mesh networks, local relays, analog mechanical linkages, quantum entanglement channels, biochemical coupling pathways, ritualistic synchronization methods, or any other digital, mechanical, biological, chemical, neural, symbolic, or hybrid connection mechanism upon any form of initialization, activation, handshake, or state exchange, perform a jurisdictional compliance evaluation against applicable local, national, and international safety, privacy, export-control, and ethical regulations, and automatically disable, degrade, or restrict any high-risk features, operations, or gestures that conflict with such regulations or that have not obtained requisite consent, certification, or authorization, logging any such compliance actions in real time.
4.

A method claim mandating that each session, shared experiential conduit, or interactive instance implementing the Milly Protocol record in an immutable, cryptographically secured log comprehensive metadata including but not limited to user identity and consent records, device and sensor fingerprints, protocol and firmware version numbers, transaction hashes, geographic and temporal stamps, compliance status flags, and audit trail entries for every action, signal, and state change, such that the entire history of remote object manipulation, sensory feedback delivery, biometric modulation, and compliance enforcement is permanently preserved, verifiable, and admissible for enforcement, licensing audits, or regulatory review.
5.

An overarching means-plus-function clause covering any mechanism, whether now known or later developed, by which an event, state, or signal at one user's location influences perception, behavior, or object state at another user's location encompassing digital protocols, hardware assemblies, software routines, AI-driven proxies or avatars, neural entrainment techniques, chemical or pheromonal broadcasts, symbolic or language-based rituals, or any combination of these such that remote object interaction, co-presence, or empathic feedback is achieved, and declaring that all such mechanisms and implementations constitute equivalent embodiments of the patented invention.
6.

Locate the section of your CIP specification immediately following your “Key Innovations” or “Future Improvements” paragraphs. Insert the following under a new heading Alternative Embodiments (or Example Implementations):
7.

### ALTERNATIVE EMBODIMENTS

### Software-Only Implementation

A purely software-based embodiment may be implemented as a cloud-native service or mobile application that provides the Milly Protocol's functionality without dedicated haptic hardware.

The system comprises:

Session Manager Module: establishes and maintains session state and object data synchronization over WebSockets or gRPC.

Feedback Engine Module: maps incoming object force and motion parameters to device API calls (e.g. Android Vibrator. vibrate( ), iOS CoreHaptics, WebHID for VR controllers).

Predictive Synchronization Module: a machine-learning component (e.g. TensorFlow-based) that forecasts next-state feedback values to mask network latency.

```
function onRemoteEvent(evt) {let pred = Predictor.predict(evt.force,
evt.velocity);
  FeedbackEngine.applyHaptic(pred);
  Renderer.updateObject(evt.objectId, evt.position);}
```

8.

### OLFACTORY FEEDBACK MODULE

An Olfactory Feedback Module may be added by connecting a scent-emitter device via BLE. The Milly Protocol outputs a scentIntensity parameter which is written to a BLE characteristic on the emitter (e.g. Feel Real VR mask). Upon receiving the value, the device releases timed odorant puffs synchronized with object interactions.
9.

### SUPPORT AND SCOPE

These embodiments are exemplary only. The invention likewise covers any now-known or hereafter-developed means mechanical, chemical, biological, software-only, or quantum for delivering the claimed feedback signals, provided the functional mapping from object state to user perception is preserved
10.

A declaratory clause stating that any future dependent claims, embodiments, protocol versions, AI extensions, sensor modalities, interface improvements, synchronization techniques, or disclosed enhancements by Zebrak Holdings Inc., whether described in subsequent patent filings, continuation-in-part applications, whitepapers, technical disclosures, standards submissions, or product documentation, shall automatically inherit the original filing date of this application, be deemed to form part of the same patent family, and enjoy full priority and enforceability as if originally filed hereunder.

This section is new text added to comply with the rules.

### Photo 1

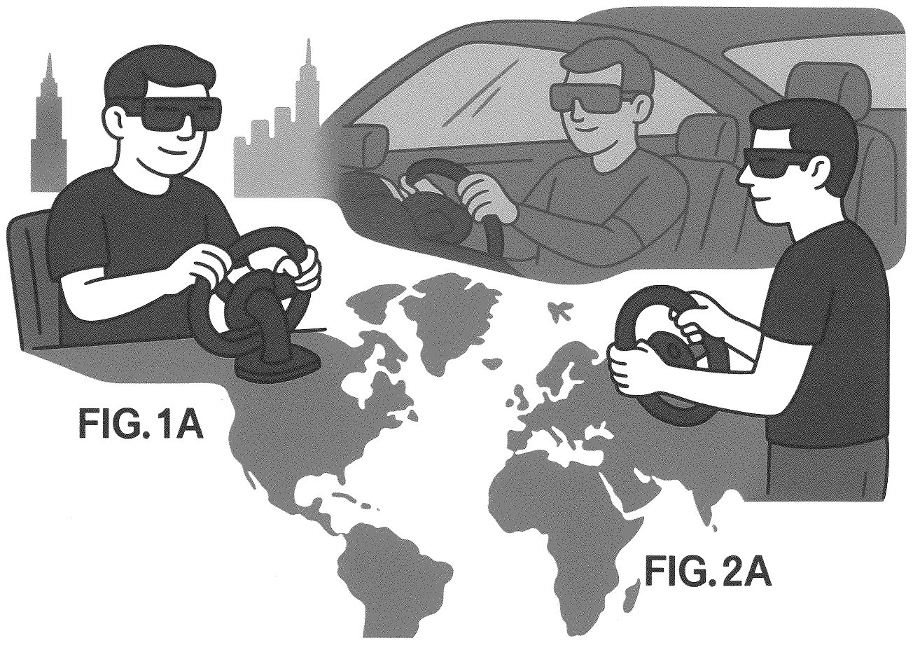

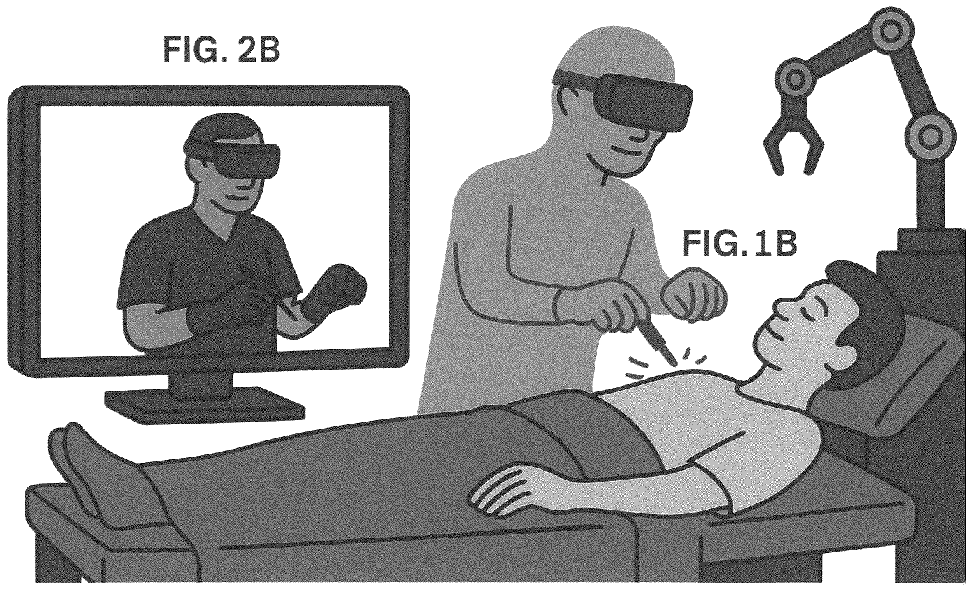

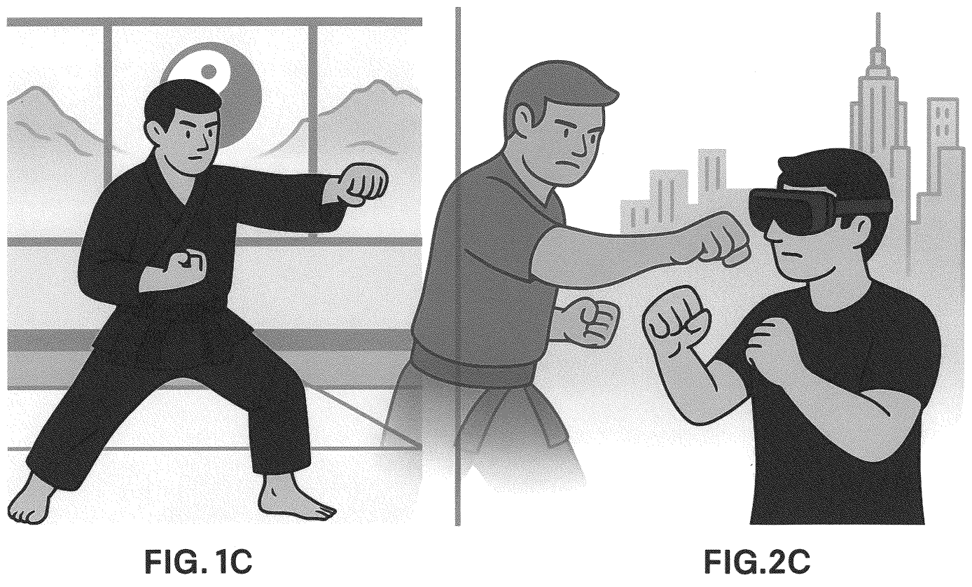

FIG. 1A illustrates a first user positioned at a first physical location, equipped with augmented reality display hardware and haptic feedback devices, interacting with a shared virtual or physical object through the disclosed synchronization system.

FIG. 2A illustrates a second user positioned at a second physical location, similarly equipped with augmented reality display hardware and haptic feedback devices, concurrently interacting with the same shared virtual or physical object as the first user, demonstrating real-time bidirectional object state synchronization.

### Photo 2

FIG. 1B illustrates a first user positioned at a first location, actively engaging with a shared object via augmented reality visual overlays and haptic feedback mechanisms within the disclosed system. A patient figure is also shown lying on a surgical table, provided for environmental context only and not labeled as a separate figure.

FIG. 2B illustrates a second user at a separate location, concurrently interacting with the same shared object through corresponding augmented reality and haptic feedback devices, showing bidirectional synchronization of touch and movement between both users.

### Photo 3

FIG. 1C illustrates a system overview showing two users positioned at separate physical locations, each equipped with augmented reality display hardware and haptic feedback devices. Both users interact with a shared virtual or physical object represented within a networked environment, demonstrating bidirectional synchronization of object state, position, and haptic feedback across locations as enabled by the Mimicking Milly Protocol.

FIG. 2C illustrates a corresponding user located at a remote physical site, equipped with augmented reality eyewear and a haptic-enabled wearable interface. This user engages with the same shared virtual or physical object in real time, experiencing synchronized force feedback, object movement, and spatial updates. The figure emphasizes the system's capacity for cross-location interaction fidelity, allowing the user to perceive and respond to remote actions as if physically co-present, as governed by the Mimicking Milly Protocol.

1. A system for remote physical object interaction comprising: at least one augmented reality interface, a feedback delivery module, and a synchronization protocol enabling shared manipulation of a virtual or physical object across two or more user endpoints.

2. The system of claim 1, wherein the feedback delivery module provides haptic signals including tactile, vibrational, auditory, and thermal cues in response to user interaction.

3. The system of claim 1, wherein the feedback delivery module further includes olfactory, gustatory, nociceptive, vestibular, magnetic, or neurostimulation-based output mechanisms.

4. The system of claim 1, wherein the synchronization protocol operates over a peer-to-peer mesh, centralized server, or hybrid network to transmit object state changes in real time.

5. The system of claim 1, further comprising a compliance evaluator configured to assess safety, privacy, export control, and ethical constraints per jurisdiction and disable non-compliant features dynamically.

6. The system of claim 1, wherein interaction logs are recorded in a cryptographically secured immutable ledger containing session metadata including user identity, consent, protocol version,. and event timestamps.

7. The system of claim 1, wherein the object comprises any entity recognized as manipulable across endpoints, including AI-generated forms, algorithmic constructs, or ambient phenomena such as soundscapes or electromagnetic fields.

8. The system of claim 1, wherein feedback signals are delivered via wearable devices, implantable components, ambient emitters, chemical dispersion, or software-only application programming interfaces.

9. The system of claim 1, further comprising a predictive synchronization engine that anticipates object state transitions and renders feedback in advance of full data transmission.

10. A software-only embodiment of the system of claim 1, comprising a mobile or cloud-based application utilizing native device APIs to simulate physical feedback without external hardware.

11. The system of claim 10, wherein software-only feedback is delivered using device-native capabilities such as vibration motors, display brightness shifts, audio cues, or augmented visual overlays.

12. The system of claim 1, wherein feedback is modulated by AI based on user biometric state, emotional condition, or interaction history.

13. The system of claim 1, further comprising symbolic or ritual-based synchronization triggers used to initiate interaction events in culturally adaptive contexts.

14. A method for implementing the system of claim 1, comprising: initializing user sessions, synchronizing shared object states, delivering feedback based on user interaction, logging all state changes, and enforcing jurisdictional compliance.

15. A universal means-plus-function clause covering any mechanism by which a user's action or perception is mirrored or influenced at another user's location to enable co-presence, empathy, or remote collaboration.
